(19) United States
(12) Patent Application Publication
(10) Pub. No.: US 2026/0017523 A1
(43) Pub. Date: Jan. 15, 2026

(54) SELF-SUPERVISED LEARNING FOR DEVELOPING TEMPORALLY AGNOSTIC TRANSFORMERS

(71) Applicant: Capital One Services, LLC, McLean, VA (US)

(72) Inventor: Samuel SHARPE, Cambridge, MA (US)

(73) Assignee: Capital One Services, LLC, McLean, VA (US)

(21) Appl. No.: 18/772,090

(22) Filed: Jul. 12, 2024

(51) Int. Cl. G06N 3/0895

(52) U.S. Cl. CPC G06N 3/0895

(57) ABSTRACT

Methods and systems are described herein for training and implementing a temporally agnostic transformer model. To train the transformer model, event sequence data associated with users is modified by selecting pairs of events and switching an ordering of those events within the sequence. The modified event sequence data is provided to a transformer model, which produces an attention matrix indicating which pairs of events the model focused on when performing its predictions. Using a reference matrix, attention values associated with the switched pairs of events can be identified and the cross entropy can be maximized. This optimization can be used to update the transformer model to obtain a transformer model that is agnostic to event ordering.

### BACKGROUND

While transformer models have become increasingly popular in machine learning, they lack the ability to understand timing contextually within data when generating predictions. One reason for this is that transformer models, traditionally, have been trained to handle sequences of text, not sequences of events. Learning to understand how the timing of events and the ordering of those events impact predictions is crucial for adapting transformer models for different applications. This technical limitation presents a problem when attempting to train and use transformer models to predict events and/or classify sequences, as well as understand the components from which the predictions are made.

### SUMMARY

Methods and systems are described herein for developing temporally agnostic transformer models. In particular, the techniques described herein train transformer models to recognize perturbations in event sequences and account for those perturbations when making event predictions. These technical solutions enable an improved transformer model to be developed that is able to better (i) understand how event order impacts predictions and (ii) detect data anomalies within user time series data.

Many transformer models are designed to process sequences of data, such as text. The transformer models produce attention matrices that indicate how relevant each component of the text is with respect to one another. Thus, the attention matrices can contextualize the text to identify which words were “important” when making predictions. However, while transformer models are powerful tools to process certain input data types, such as text, they have difficulty dealing with other types of input data, such as time series data. Like text, time series data also has an ordered structure. With text, the ordering relates to the grammatical and contextual structuring of the subject being described. In this sense, the “timing” of each text token is not applicable. However, with time series data, which generally includes a series of events that occur at different times, the times when each event occurs and the order of those events are not only applicable but critical to the transformer models' understanding.

The disclosed embodiments relate to techniques for training a transformer model (or another deep learning model) to be agnostic to time and, in particular, order when analyzing time series data. In particular, the time series data may include event sequence data representing a sequence of events. Each event in the sequence may occur at a particular time (e.g., a first event occurs at a first time, a second event occurs at a second time, and so on) of an interaction between a user and a computing system (e.g., a service provider server, a service provider device, another user device, etc.). These interactions may describe behaviors of the user and can be used to understand and model user behaviors, such as user interactions with the computing system, as well as formulate predictions for future events and classifications.

In some embodiments, event sequence data associated with a plurality of users may be obtained. The event sequence data may include various sequences of events for the users. For each sequence of events, one or more pairs of events may be selected. For example, a first event occurring at a first time and a second event occurring at a second time may be selected from a sequence of events of a user. The ordering of the events (from the pairs) may be switched—for instance, the first event may be switched to occur at the second time and the second event may be switched to occur at the first time. The sequence of events including the switched pair(s) may form modified event sequence data, which may be fed to a transformer model to generate embeddings for each of the events in the (modified) sequence of events. Using the generated embeddings, an attention matrix indicating which embeddings, and thus events, are most “important,” can be generated. An element-wise comparison may be performed via a loss function between the attention matrix and a reference matrix, which indicates the pair(s) of events that were switched, can be computed to identify attention values that represent how much attention the transformer model placed on the switched events. By maximizing these attention values, parameters of the transformer model can be optimized to be agnostic to time when analyzing event sequence data. This can allow the transformer model to better understand event ordering anomalies and interactions with computing systems.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRA WINGS

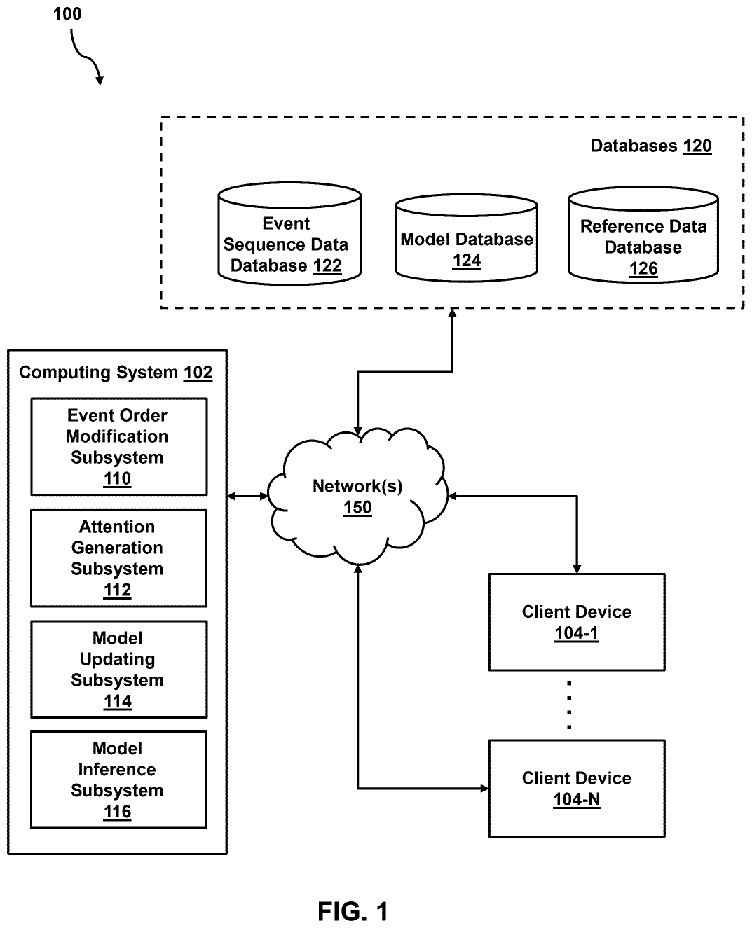

FIG. 1 shows an illustrative system for training a transformer model to be agnostic to event ordering, in accordance with one or more embodiments.

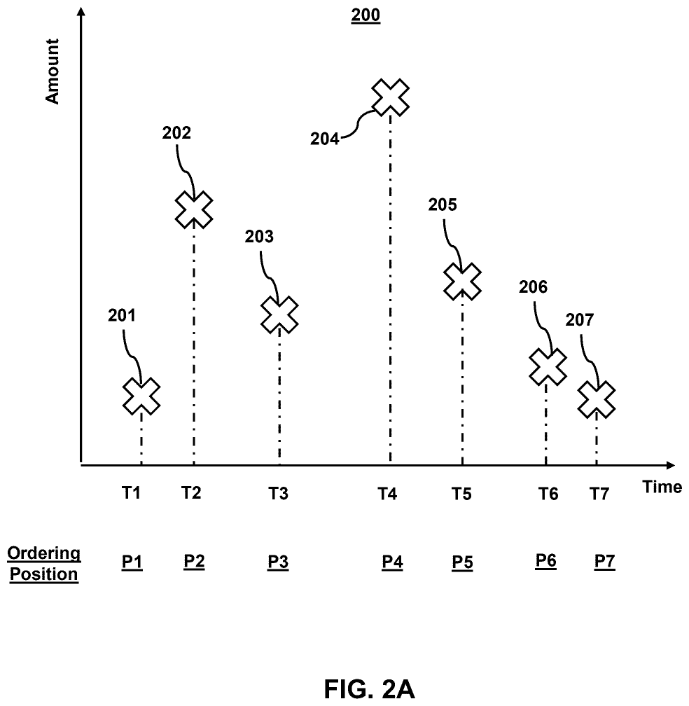

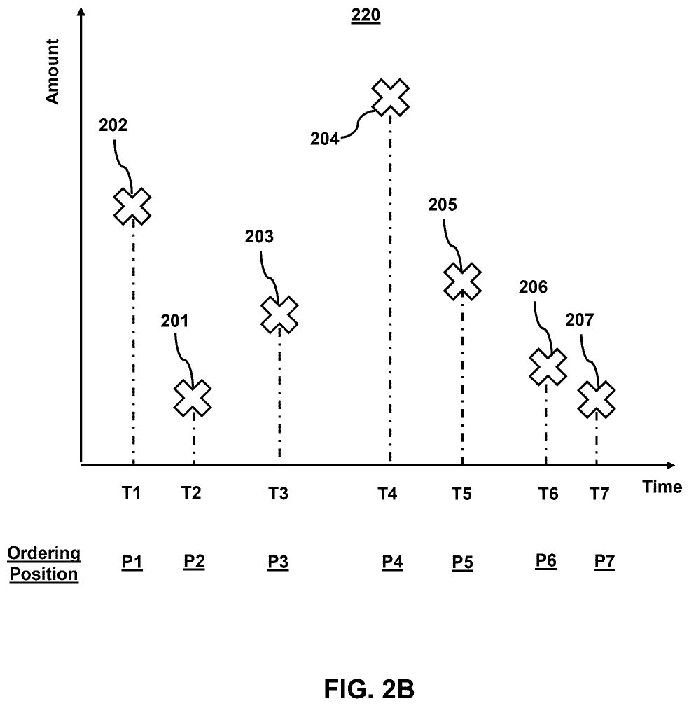

FIGS. 2A-2B illustrate example event sequence data and modified event sequence data, respectively, in accordance with one or more embodiments.

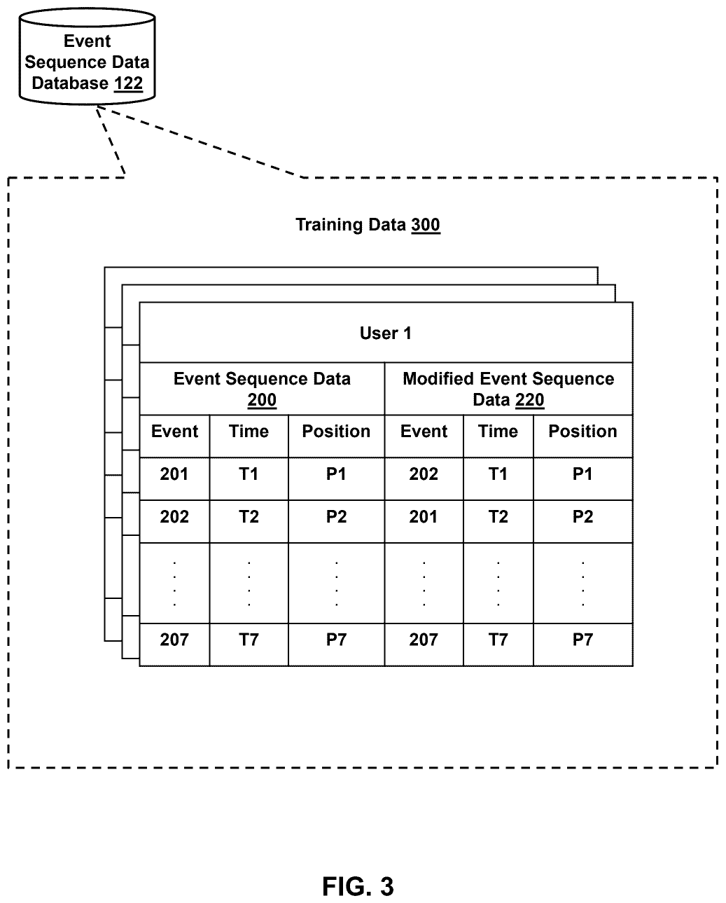

FIG. 3 illustrates example training data for training a transformer model, in accordance with one or more embodiments.

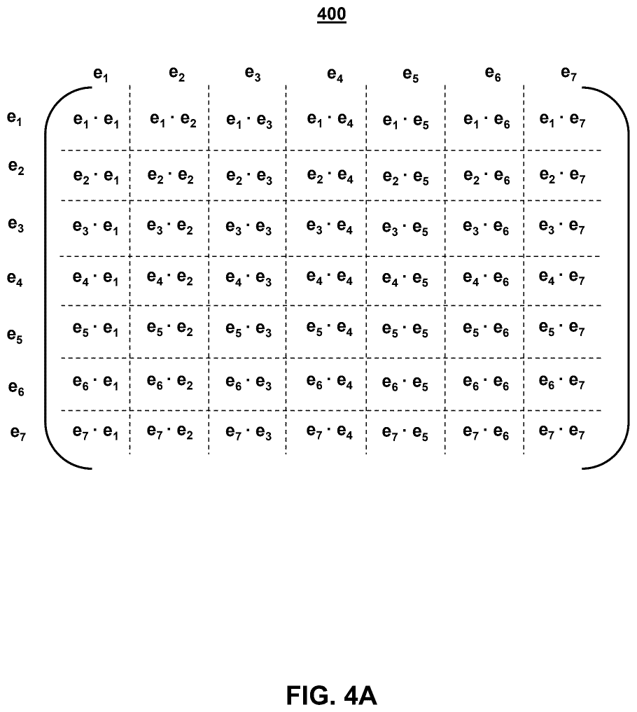

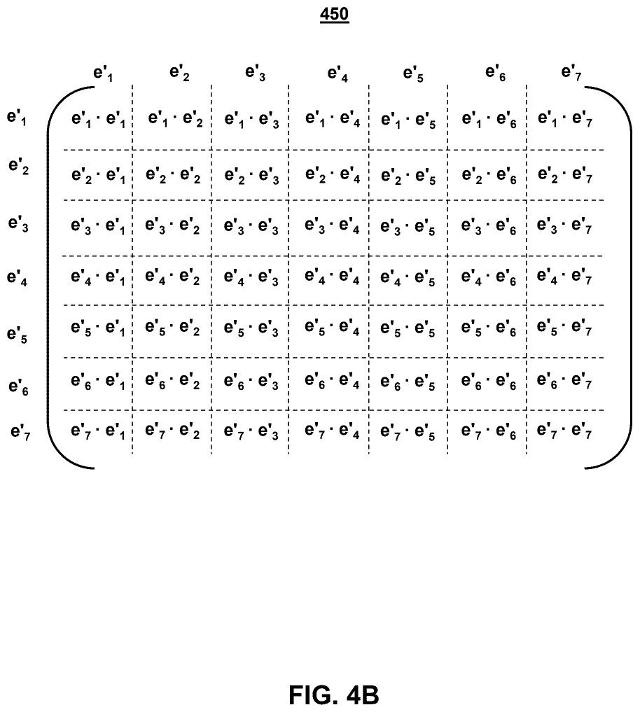

FIGS. 4A-4B illustrate example attention matrices formed from event sequence data and modified event sequence data, respectively, in accordance with one or more embodiments.

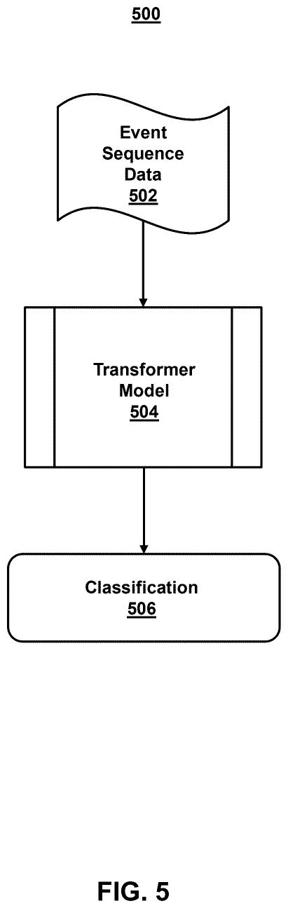

FIG. 5 illustrates an example classification process for classifying event sequence data using a transformer model, in accordance with one or more embodiments.

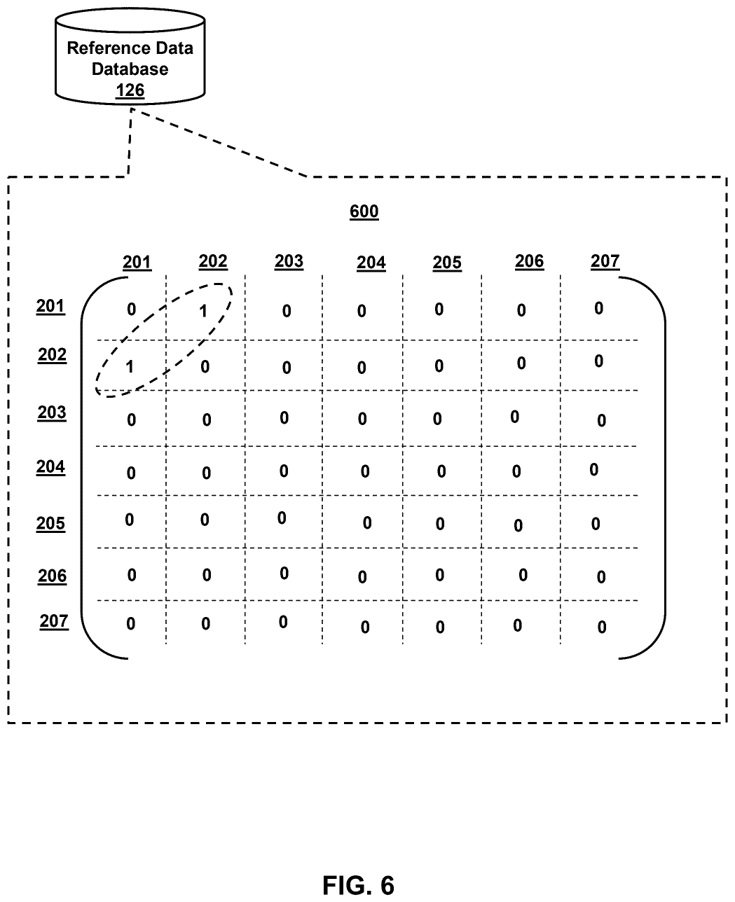

FIG. 6 illustrates an example reference matrix indicating which pairs of events within a sequence were switched, in accordance with one or more embodiments.

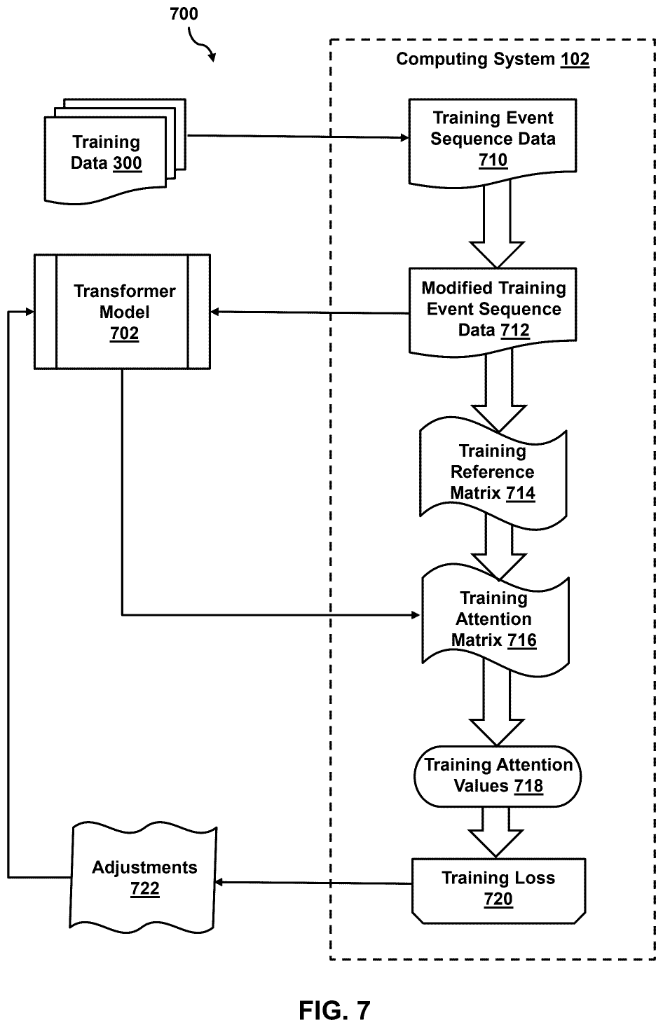

FIG. 7 illustrates an example training process for training a transformer model to be agnostic to event ordering, in accordance with one or more embodiments.

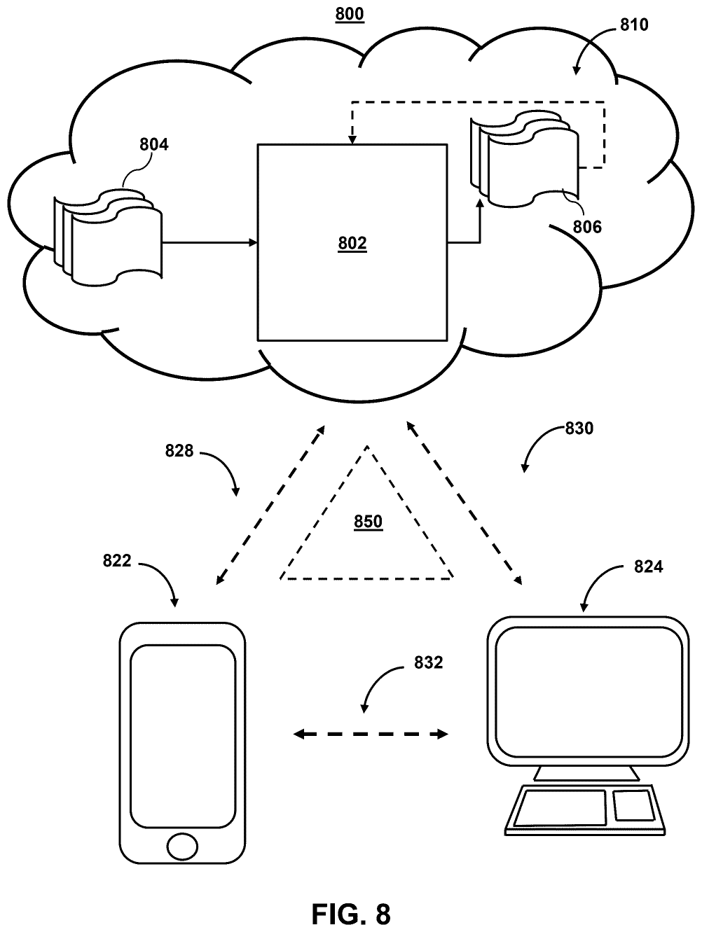

FIG. 8 illustrates an example system for developing and using a temporally agnostic transformer model, in accordance with various embodiments.

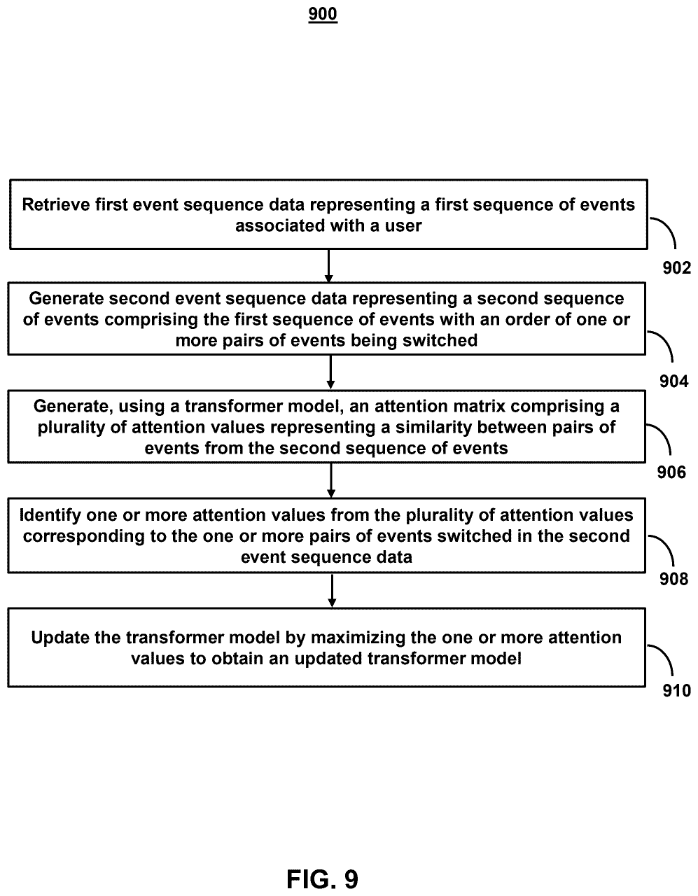

FIG. 9 illustrates a flowchart of an example process for training a transformer model to be agnostic to event ordering, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Transformer models are designed to process sequences of data, such as text. The transformer models produce attention matrices that indicate how relevant each component of the text is with respect to one another. Thus, the attention matrices can contextualize the text to identify which words were “important” when making predictions. However, while transformer models are powerful tools to process certain input data types, such as text, they have difficulty dealing with other types of input data, such as time series data. For instance, time series data generally incudes a series of events that occur at different times. The intervals between these times, however, may not be uniform. This raises issues when trying to understand why a transformer model made certain predictions. For example, is a certain attention score large, and thus more important to the downstream classifications, because of the amount of time between when two events occurred or because the events are, themselves, important.

While the foregoing description primarily relates to transformer models, persons of ordinary skill in the art will recognize that other artificial intelligence models may be used instead of or in addition to a transformer model. For example, Recurrent Neural Networks (RNNs), Temporal Convolutional Networks (TCNs), Graph Neural Networks (GNNs), or other artificial intelligence models, or combinations thereof, can be used to generate embeddings and make predictions based on the generated embeddings. Furthermore, descriptions relating to a single artificial intelligence model should not be construed to mean that only one model is used, and some examples may utilize an ensemble model formed of two or more models working together to develop predictions and perform other tasks (e.g., classifications).

FIG. 1 shows an illustrative system for training a transformer model to be agnostic to event ordering, in accordance with one or more embodiments. System 100 may include a computing system 102, client devices 104-1 through 104-N (collectively, and interchangeably, referred to herein as “client devices 104”), databases 120 (for example, including an event sequence data database 122, a model database 124, and a reference data database 126), and/or other components. Computing system 102, client devices 104, databases 120, and/or any other devices, servers, and/or systems may communicate with one another using one or more networks 150 (e.g., the Internet, an intranet, or other communications network).

In some embodiments, only one client device (i.e., one of client devices 104) may be used, while in other embodiments, multiple client devices (i.e., two or more client devices 104) may be used. Client devices 104 may be associated with one or more users. Client devices 104 may be associated with one or more user accounts. For example, a client device 104 may have an account with a service provider or may be used to access the account with the service provider. In some embodiments, client devices 104 may be computing devices that may receive and send data via network 150. Client devices 104 may be end-user computing devices (e.g., desktop computers, laptops, electronic tablets, smartphones, and/or other computing devices used by end users). Client devices 104 may output (e.g., via a graphical user interface) data, run applications, output communications, receive inputs, or perform other actions.

In some embodiments, computing system 102 may be in communication with, or form a component of, a service provider. For instance, the service provider may include or otherwise be associated with a computing system (e.g., a cloud-based service, a distributed server system, a mesh network of devices, etc.) and/or may form a portion of computing system 102. In other words, the service provider has its own computing system—which may be the same as or similar to computing system 102—and/or may leverage aspects of computing system 102 to respond to requests, queries, or other actions. For example, the service provider may route requests to computing system 102, which may analyze and determine responses to the requests, which in turn may route the responses to the service provider. As another example, the service provider and computing system 102 may form a single system.

Computing system 102 may include an event order modification subsystem 110, an attention generation subsystem 112, a model updating subsystem 114, a model inference subsystem 116, or other subsystems. Each of event order modification subsystem 110, attention generation subsystem 112, model updating subsystem 114, and model inference subsystem 116 may be implemented using computer programming instructions executing on one or more processors (e.g., graphics processing units (GPUs)). In some examples, dedicated hardware may be used to execute the instructions associated with one or more subsystems. In some examples, event order modification subsystem 110, attention generation subsystem 112, model updating subsystem 114, and model inference subsystem 116 may be implemented using one or more cloud computing resources. For example, container instances may be provisioned (or selected if warm) to perform tasks represented by each subsystem's corresponding programming instructions.

In some embodiments, computing system 102 may include, be in communication with, facilitate the execution of, or otherwise interface with a transformer model. Transformer models may process and analyze large amounts of data through deep learning techniques. Typically, a transformer model may begin by ingesting massive datasets, which can include text, images, event sequences, or other types of information. The transformer then uses this data to train itself by learning patterns, relationships, and structures within the data. One of the key features of transformer models is their use of attention mechanisms. This approach allows the transformer to focus on different parts of the input data when making predictions or generating responses. For instance, in natural language processing (NLP) applications, a transformer model may pay more attention to specific words or phrases in a sentence that are crucial for understanding the context and meaning. Another aspect of these models is their ability to handle sequential data, such as text or time series data, in a way that does not rely on the sequential processing used in other types of models. Instead, transformers can process entire sequences of data simultaneously, which often results in more efficient and effective learning. Since transformer models do not inherently capture the sequential nature of the input, for some NLP applications positional encodings may be added to the input embeddings to provide information about the position of words in the sequence. Transformers often utilize an encoder-decoder architecture, where the encoder processes the input sequence, and the decoder generates the output sequence. This architecture may be used for sequence-to-sequence tasks like machine translation and text summarization.

As mentioned above, text data refers to strings of text that can be input into the transformer model. As an example, in the context of machine translations, the transformer model may receive a sentence in a first language, determine an importance of each word in the sentence to one another (i.e., using the attention mechanisms), and output a translated sentence in a second language based on the determined importance of each word from the original sentence. However, transformer models can also be used to analyze and perform predictions based on event sequence data. Event sequence data refers to a sequence of events. These events may represent various interactions between a user (e.g., a user of client device 104) and one or more servers, such as a service provider's server. In some examples, the interactions may include communications detected between the user and the server. For example, the interactions may include voice calls, short messaging service (SMS) messages, emails, chatbot communications, or other forms of communications. In some examples, the interactions may represent instances where a user interfaces with an application associated with the server via client device 104 (i.e., a mobile application). For instance, the events may include interactions of a user with a mobile application of a service provider. As still yet another example, the interactions may include interactions between a user and one or more computing systems associated with a service provider's server. For instance, the events may include interactions of the user with communications kiosks (e.g., ATMs), brick-and-mortar stores, or other access points affiliated with the service provider.

In some cases, the timing between events within a given sequence of events may vary. As an example, with reference to FIG. 2A, event sequence data 200 may include events 201-207 occurring at times T1-T7, respectively. In some embodiments, events 201-207 may indicate a first ordering (i.e., a sequence) of the events-event 201 occurring at time T1 is the first event within the first sequence; event 202 occurring at time T2 is the second event within the first sequence; event 203 occurring at time T3 is the third event within the first sequence; event 204 occurring at time T4 is the fourth event within the first sequence; event 205 occurring at time T5 is the fifth event within the first sequence; event 206 occurring at time T6 is the sixth event within the first sequence; and event 207 occurring at time T7 is the seventh event within the first sequence.

Similar to sequences of text, which may include positional encoding indicating each text token's position within the sequence of text, event sequence data 200 may also include ordering position encoding indicating a given event's position within the sequence of events. For example, events 201-207 may include ordering positions P1-P7 indicating each event's position within the sequence. For example, ordering position P1 may be assigned to event 201, indicating that event 201 is the first event within the sequence of events represented by event sequence data 200. Similarly, ordering positions P2-P7 may be assigned to events 202-207, respectively, indicating each event's order within the sequence of events represented by event sequence data 200.

In one or more examples, the time between events may be the same or different. For example, the time difference between event 201 and event 202 may be Δ₁₂=|T1−T2|, while the time difference between event 202 and event 203 may be Δ₂₃=|T2−T3|. Time difference 423 and 412 may be the same or different. Similarly, the times between each of events 201-207 may differ. In some embodiments, the time difference between events may provide contextual information about some or all of the events in the sequence. For example, two events that occur temporally close to one another may indicate that those two events are related, and thus the transformer model may determine that additional emphasis may be placed on these events when processing event sequence data 200 (e.g., forming a prediction). As another example, events that are temporally spaced out may indicate to the transformer model that those events are unrelated.

The process of training a transformer model may involve adjusting the model's internal parameters to minimize the difference between its outputs and the correct answers or desired outcomes. This process, referred to as optimization, may rely on various algorithms. Once trained, transformer models may perform a wide range of tasks, such as language translation, content generation, image recognition, classifications, and more. In some embodiments, transformer models may be adapted to other contexts as well. For example, to predict events, transformers may analyze data, identifying patterns and relationships that may not be immediately apparent. They may do this by focusing on specific segments of the data that are more relevant for making accurate predictions. By ingesting large datasets that capture different aspects of behavior, such as many different historical events, these models can learn underlying patterns and decision-making processes. This learning may enable transformer models to simulate or predict future events under varying conditions.

Returning to FIG. 1, event order modification subsystem 110 may be configured to retrieve first event sequence data representing a first sequence of events associated with a user. In some embodiments, event order modification subsystem 110 may be configured to select a user from a plurality of users and may retrieve that user's event sequence data from event sequence data database 122. Each of the plurality of users may have their own event sequence data stored in event sequence data database 122. The event sequence data associated with each user may represent a sequence of events (e.g., events 201-207 of FIG. 2A) associated with the user. Each event may correspond to an interaction between the user and a computing system (e.g., a server). For example, the interactions may comprise interactions between a client device of the user and a service provider's computing system. In some embodiments, the event sequence data for each of the users may be retrieved in parallel and/or serially.

The event sequence data of each user may be input to the transformer model. In some embodiments, event sequence data of a first user may be input to the transformer model and, subsequent to computing a loss and updating parameters of the transformer model, event sequence data of a second user may be input to the transformer model. However, the event sequence data for each user may be input to separate transformer models (e.g., instances of the transformer model running on separate computing resources).

In some embodiments, event order modification subsystem 110 may be configured to generate second event sequence data representing a second sequence of events. The second sequence of events may include the same events as the first sequence of events, albeit having a different order. For example, an order of one or more pairs of events from the first sequence of events may be switched with the second sequence of events.

In one or more examples, the first sequence of events comprises a plurality of events (e.g., 2 or more events, 100 or more events, 1,000 or more events, 10,000 or more events, and the like). As an example, with reference again to FIG. 2A, event sequence data 200 may represent a first sequence of events including events 201-207. In event sequence data 200, events 201-207 may be structured in a first ordering where event 201 occurs at position P1 within the sequence, event 202 occurs at position P2 within the sequence, event 203 occurs at position P3 within the sequence, event 204 occurs at position P4 within the sequence, event 205 occurs at position P5 within the sequence, event 206 occurs at position P6 within the sequence, and event 207 occurs at position P7 within the sequence.

Event order modification subsystem 110 may be configured to select, from the plurality of events, one or more pairs of events to be switched. Each pair of events includes two events-a first event occurring at a first time within the first sequence of events and a second event occurring at a second time within the first sequence of events. For example, event order modification subsystem 110 may select a pair of events including event 201 and event 202. To generate the second event sequence data, event order modification subsystem 110 may be configured to generate the second sequence of events comprising the events of the first sequence of events whereby the ordering of the selected pair of events is switched (i.e., the first event is switched to occur at the second time and the second event is switched to occur at the first time). As an example, with reference to FIG. 2B, modified event sequence data 220 may also include events 201-207; however, the ordering of events 201-207 within the modified sequence of events of modified event sequence data 220 may differ from the sequence of events of event sequence data 200 from FIG. 2A. For instance, in event sequence data 200, event 201 occurring at time T1 is assigned ordering position P1, event 202 occurring at time T2 is assigned ordering position P2, and so on. However, while modified event sequence data 220 of FIG. 2B also includes events 201-207, the ordering of the events has been modified. For example, in modified event sequence data 220, event 202 may be switched to “occur” at time T1 and be assigned ordering position P1 and event 201 may be switched to “occur” at time T2 and be assigned ordering position P2. Events 203-207 may, in the illustrated examples, have the same ordering position within the examples of event sequence data 200 and modified event sequence data 220. If additional pairs of events were selected, then the ordering positions assigned to those events would also be switched. For example, if events 205 and 206 were selected to be switched, modified event sequence data 220 would include event 206 being assigned ordering position P5 occurring at time T5 and event 205 being assigned ordering position P6 occurring at time T6.

In some embodiments, event order modification subsystem 110 may be configured to generate and store training data comprising event sequence data 200 and modified event sequence data 220 within event sequence data database 122. In some embodiments, event order modification subsystem 110 may be configured to derive training data based on event sequence data 200 and modified event sequence data 220. For example, event sequence data 200 and modified event sequence data 220 may be used by a generative artificial intelligence model to generate synthetic event sequence data that has similar patterns and characteristics.

As an example, with reference to FIG. 3, training data 300 may include event sequence data and modified event sequence data associated with a plurality of training users. For example, training data 300 may include a training item generated from and/or derived using event sequence data 200 and modified event sequence data 220. As seen by FIG. 3, training data 300 may indicate the ordering of events 201-207 without switching any event pairs (i.e., event sequence data 200) and with one or more event pairs switched (i.e., modified event sequence data 220).

In some cases, training data 300 may include event sequence data and modified event sequence data for each training user. The modified event sequence data for each user may represent the same events from the event sequence data of that user but with an ordering of one or more pairs of events being switched. In some examples, a same number of event pairs may be selected and switched for each of the training users. Alternatively, some of the training users may have different numbers of event pairs switched within their modified event sequence data. The training users may correspond to users who have been selected—for instance, randomly—and whose interactions have been used to develop training data 300.

In some embodiments, event order modification subsystem 110 may be configured to determine a number of events included within the first sequence of events. For example, event order modification subsystem 110 may determine that event sequence data 200 includes seven events (e.g., events 201-207) and, based on this determination, may determine that a single pair of events are to be selected and subsequently switched when creating the modified event sequence data. Based on the number of events, event order modification subsystem 110 may be configured to determine a number of pairs of events whose order is to be switched. In some embodiments, the more events included within a given sequence of events, the more pairs of events that may be switched. For example, if the sequence of events includes fewer than a first threshold number of events (e.g., less than 10 events, less than 100 events, less than 1,000 events, etc.), then a first number of event pairs (e.g., one pair of events, two pairs of events, five pairs of events, etc.) may be selected and their respective orderings switched. As another example, if the sequence of events includes more than a second threshold number of events (e.g., more than 100 events, more than 1,000 events, more than 10,000 events), then a second number of event pairs (e.g., 10 pairs of events, 100 pairs of events, etc.) may be selected and their respective orderings switched.

As described herein, switching an ordering of a pair of events refers to switching which event of the pair of events occurs first within a sequence of events. In this example, the switching of the ordering may also be referred to as flipping the order. In some examples, however, two or more events may be selected, and their ordering switched. For example, three events (e.g., events 201-203) may be selected, and their ordering may be adjusted (e.g., event 201 may be switched from being at ordering position P1 within event sequence data 200 to being at ordering position P2 within modified event sequence data 220, event 202 may be switched from being at ordering position P2 within event sequence data 200 to being at ordering position P3 within modified event sequence data 220, and event 203 may be switched from being at ordering position P3 within event sequence data 200 to being at ordering position P1 within modified event sequence data 220).

Returning to FIG. 1, in some embodiments, attention generation subsystem 112 may be configured to generate, using a transformer model, an attention matrix. The attention matrix may include a plurality of attention values representing similarities between pairs of events. As mentioned previously, transformer models use attention mechanisms to learn to focus on different parts of the input data when making predictions or generating responses. In the context of time series data, such as event sequence data, the attention mechanisms may allow the transformer model to pay more attention to specific events, or groups of events, within a sequence of events that are crucial for understanding the context and behaviors of the data. Event sequence data refers to a sequence of events that occur at various times. These events may represent various interactions between users and one or more computing systems (e.g., a server associated with a service provider).

In some examples, events 201-207 may relate to a person, an account, a service, or another entity's behavior over time. The transformer model may be trained to model and predict events (e.g., actions, activities, transactions, or other events) associated with an entity based on a sequence of events performed by that entity in the past (e.g., the time series data). In some embodiments, the transformer model may be configured to generate event embeddings for events 201-207 of FIGS. 2A-2B. Each event embedding may encapsulate information such as a time and location of an event associated with the entity, other related entities, its type or category (e.g., credit card transaction, default, cancellation of a card, credit check, etc.), and other relevant contextual details. The transformer model may perform a transformation on each embedding and may generate an attention matrix using the transformations.

In some embodiments, attention generation subsystem 112, via a transformer model or other artificial intelligence model, may be configured to receive or generate embeddings for a sequence of events. These embeddings may be representations of the events in a continuous vector space. Event embeddings may be similar to word embeddings in NLP, where words are represented as dense vectors in a continuous space, capturing semantic relationships between words. In the context of event sequence data, the event embeddings may encode information about events, their relationships to one another, and other information that can be used to form predictions. The embedding, which is referred to herein interchangeably as an “event embedding,” comprises a representation of temporal and structural properties associated with a corresponding event. In particular, a given event embedding encodes information regarding prior events in the sequence. Thus, a given event's embedding is not only dependent on that event's characteristics but also is dependent on any prior events that occurred. For this reason, different orderings of the same events can produce different embeddings.

The embeddings may be created using various techniques and may be used in sequential data analysis, recommendation systems, time series analysis, and other applications dealing with event sequences. In some embodiments, an embedding may be generated using sequential models (e.g., RNNs, transformers, etc.). Models such as RNNs or transformer model-type architectures may learn embeddings from event sequences by processing them sequentially. These models may capture dependencies between events and generate embeddings based on the sequence context. TCNs use convolutional operations to learn event embeddings by considering temporal dependencies in event sequences. Event data may also be represented as a graph, where events are nodes, and relationships between events are edges. Graph embedding techniques may aim to learn representations for events based on their connectivity and interactions in the graph. Event embeddings may capture various properties of events, such as event types, temporal relationships, contextual information, and dependencies among events in a sequence. These embeddings may be used in downstream tasks like event prediction, anomaly detection, recommendation systems, and more, providing a compact and meaningful representation of event data.

Attention generation subsystem 112, itself or via a transformer model, may generate event embeddings for events 201-207 based on a first sequence of those events (e.g., event sequence data 200) and/or a second sequence of those events (e.g., modified event sequence data 220). In some examples, each embedding may represent a portion of the sequence it represents. For example, with reference to event sequence data 200 of FIG. 2A, a first embedding may be generated for event 201, a second embedding may be generated for event 202, and so on. Each embedding may represent the sequence including all events that occurred prior to a given event. For example, the second embedding representing event 202 may include information about first event 201 because first event 201 is part of the sequence of events up until, and including, second event 202. Similarly, a third embedding representing event 203 may include information about first event 201 and second event 202. In this way, as more events are detected, the sequence changes by adding new data points and the embedding representing the events in the sequence also changes.

In some embodiments, events 201-207 may include a first event (e.g., a query event) and second events (e.g., key events). The query event may be associated with a query event embedding and the key events may be associated with key event embeddings. For example, the query event and each key event may be converted into a high-dimensional vector using a learned embedding layer of a transformer model. This initial embedding may capture the essential features of each event in a format the transformer model can process. Once the initial embeddings are created, the transformer model may apply separate linear (or other) transformations to these embeddings to produce the query embedding and the key embeddings. These transformations may be facilitated by learned weights that are specific to each type of vector, as previously discussed. For the query and key vectors, these transformations may be designed to prepare the embeddings for the attention mechanism. The query embeddings may represent the elements for which the model is trying to determine relevance, while the key embeddings may correspond to the elements against which the query is compared. The transformer model may then use these query and key embeddings in the attention mechanism. In some embodiments, the query and key embeddings may represent, for a corresponding event, how that event would fit into a sequence of other events. For example, the embeddings may represent the context in which each corresponding event occurs.

FIGS. 4A-4B illustrate example attention matrices 400 and 450 formed from event sequence data and modified event sequence data, respectively, in accordance with one or more embodiments. With reference to FIG. 4A, attention matrix 400 may include a plurality of attention values, each determined by computing a dot product of an embedding e; with each other embedding eⱼ. In some embodiments, embedding e; may include positional information indicating an ordering position of a corresponding event (e.g., the i-th event) within a sequence of events. For example, embedding e; may represent a first event from event sequence data 200 capturing structural and temporal information associated with the first event (e.g., event 201 at position P1), embedding e₂ may represent a second event from event sequence data 200 capturing structural and temporal information associated with the second event (e.g., event 202 at position P2), embedding e may represent a third event from event sequence data 200 capturing structural and temporal information associated with the third event (e.g., event 203 at position P3), and so on. As noted above, the structural and temporal information associated with a given event may also include structural and temporal information associated with any prior events.

With reference to FIG. 4B, attention matrix 450 may include a plurality of attention values, each determined by computing a dot product of an embedding e′ᵢ with each other embedding e′ⱼ. As used herein, the “′” is used to indicate that an embedding is associated with a modified sequence of events where an ordering of one or more pairs of events were switched. In some embodiments, embedding e′ᵢ may include positional information indicating an ordering position of a corresponding event (e.g., the i-th event) within the modified sequence of events. For example, embedding e′₁ may represent a first event from modified event sequence data 220 capturing structural and temporal information associated with the first event (e.g., event 202 at position P1), embedding e₂ may represent a second event from modified event sequence data 220 capturing structural and temporal information associated with the second event (e.g., event 201 at position P2), embedding e₃ may represent a third event from modified event sequence data 220 capturing structural and temporal information associated with the third event (e.g., event 203 at position P3), and so on. As noted above, the structural and temporal information associated with a given event may also include structural and temporal information associated with any prior events.

In some embodiments, each event embedding may include values that represent various aspects and features of the corresponding event, capturing both explicit and implicit characteristics that define the event. The embeddings may be high-dimensional vectors where each dimension may encode different attributes or nuances of the corresponding event. As an illustrative example, each event embedding may encapsulate information such as the time and location of an event associated with an entity person (e.g., a member of an organization), its participants, its type or category (e.g., credit card transaction, default, cancellation of a card, credit check, etc.), its account, or another entity, and other relevant contextual details. For example, in each embedding of an event, certain dimensions may implicitly encode the significance or impact of the event, based on how similar events have been perceived or categorized in training data used to train the transformer model. Another dimension may encode relationships between the events, such as causality or correlation, learned through the transformer model's exposure to sequences or clusters of events in the data. In some embodiments, plotting the event embeddings in an embedding space (e.g., a high-dimensional space) may reveal that similar events are plotted close to each other while events with vastly different characteristics are plotted farther apart. In some embodiments, the event embeddings may include different event embeddings or event embeddings having different dimensions.

In some embodiments, attention generation subsystem 112 may be configured to compute, for each of the plurality of embeddings, the set of dot products between the embedding and each other embedding from the plurality of embeddings. For example, attention generation subsystem 112 may generate an attention value aᵢⱼ=eᵢ·eⱼ for each event embedding of event sequence data 200 to obtain attention matrix 400. As another example, attention generation subsystem 112 may generate an attention value a′ᵢⱼ=e′ᵢ·e′ⱼ for each event embedding of modified event sequence data 220 to obtain attention matrix 450. Each attention value aᵢⱼ, a′ᵢⱼ may indicate how similar a given embedding is with respect to each other embedding. Each attention value aᵢⱼ, a′ᵢⱼ from the set of attention values represents a likelihood that an order of a given pair of events associated with each dot product was switched.

The size of attention matrices 400 and 450 is related to a number of events included in a corresponding sequence of events. For example, attention matrices 400 and 450 include seven rows and seven columns, respectively, related to events 201-207. If more events were included in the sequence of events, then more rows and columns are included in the attention matrices. Persons of ordinary skill in the art will recognize that the diagonal elements of attention matrices 400 and 450 may be equal (for example, if i=j, aᵢᵢ=eᵢ·eᵢ=1, a′ᵢᵢ=e′ᵢ·e′ᵢ=1). Furthermore, attention matrices 400 and 450 may be symmetric (for example, aᵢᵢ=eᵢ·eᵢ=eⱼ·eᵢ=aⱼᵢ, d′ᵢ=e′ᵢ·e′ᵢ=e′ⱼ·e′ᵢ=a′ⱼᵢ,).

In some embodiments, attention generation subsystem 112 may be configured to determine, using the transformer model, a classification of the event sequence data. In one or more examples, the classification of unmodified event sequence data (e.g., event sequence data 200) may be determined prior to the transformer model being updated. For example, with reference to FIG. 5, event sequence data 502 may be input to transformer model 504. Transformer model 504 may generate an embedding based on event sequence data 502 and, using the produced embedding, may determine a classification 506 for event sequence data 502. In this example, event sequence data 502 may represent a sequence of events associated with a sample user without any modifications being made to the ordering of events within the sequence (such as, for example, event sequence data 200). In some embodiments, classification 506 may be used to provide one or more recommendations to the sample user. For example, transformer model 504 may generate an embedding representing event sequence data 502 and identify event sequences associated with one or more similar users based on the embedding.

To identify similar users, the embedding may be projected into an embedding space where other embeddings representing other event sequence data associated with other users may have been projected. Embeddings located nearby (as a function of a distance metric) in the embedding space may represent event sequence data of other similar users. Depending on the classifications of those similar users, transformer model 504 may determine the classification to assign to the sample user. In some examples, recommendations provided to those users may be provided to the sample user associated with event sequence data 502.

After the transformer model has been updated, an updated classification of the event sequence data may be determined using the updated transformer model. In some examples, the classification and the updated classification may differ. For example, if transformer model 504 classified the sample user into a first classification group based on event sequence data 200, then transformer model 504, after being updated, may be configured to classify the sample user into a second classification group based on modified event sequence data 220.

Returning to FIGS. 4A-4B, in some embodiments, attention matrices 400 and 450 may be used to optimize parameters of the transformer model. For example, one or more attention values associated with the switched events may be identified and these attention values may be maximized. The maximization may include computing a loss based on attention matrices 400 and 450. For example, a loss may be computed based on a difference between attention matrices 400 and 450. Alternatively, as discussed below, another optimization process may be used to update parameters of the transformer model, which uses a reference matrix to identify attention values to be maximized.

In some embodiments, attention generation subsystem 112 may be configured to generate an attention matrix for event sequence data associated with a plurality of sample users and/or a plurality of training users. For example, training data 300 may be analyzed to generate embeddings representing event sequence data and modified event sequence data of each training user. During training, for example, the attention matrices (e.g., attention matrices 400 and 450) for each user may be generated and used to determine which parameters of the transformer model are to be updated and how those parameters are to be adjusted, as detailed below. Furthermore, during inference stages, embeddings representing the event sequence data of the sample users may be generated using the updated transformer model and subsequently used to determine classifications for the sample users.

Returning to FIG. 1, model updating subsystem 114 may be configured to identify one or more attention values corresponding to the one or more pairs of events switched in the modified event sequence data. In some embodiments, model updating subsystem 114 may be configured to obtain a reference matrix indicating which pairs of events were switched. As an example, with reference to FIG. 6, reference matrix 600, which may be stored in reference data database 126, may indicate which pairs of events were switched. In some examples, reference matrices may be stored in training data stored within event sequence data database 122. For example, reference matrix 600 may indicate which of events 201-207 were switched within modified event sequence data 220. In some cases, the training data (e.g., training data 300) may also include reference matrices indicating the pairs of events that were switched between the event sequence data and the modified sequence data. In one or more examples, the training data may include pointers to memory blocks storing each reference matrix. For instance, the training data associated with a first user may also include a pointer to reference matrix 600.

In some embodiments, a number of entries in reference matrix 600 may be the same as a number of attention values included in attention matrices 400 and 450. For example, attention matrix 400, attention matrix 450, and reference matrix 600 may each include seven rows and seven columns. In some embodiments, each entry of reference matrix 600 may be a first value or a second value. For example, each entry may be a binary value (e.g., “0” or “1”). In these examples, an entry that has the first value (e.g., “0”) may indicate that a corresponding pair of events were not switched in the modified event sequence data. However, an entry having the second value (e.g., “1”) may indicate that a corresponding pair of events was switched in the modified event sequence data. For example, as seen by reference matrix 600, each entry may have the first value (e.g., “0”) indicating that a corresponding pair of events was not switched except for the entries associated with event 201 and event 202. These entries may have the second value (e.g., “1”) because an order of event 201 and event 202 were switched in modified event sequence data 220 as compared to event sequence data 200.

Model updating subsystem 114 may be configured to compute a product of the attention matrix and the reference matrix to identify the one or more attention values associated with the pairs of events. For example, the product of attention matrix 450 and reference matrix 600 may produce attention value a′₁₂=e′₁·e′₂. Persons of ordinary skill in the art will recognize that another attention value a′₂₁=e′₂·e′, may also be obtained; however, for simplicity, a single attention value is described. In some cases, the attention value identified may be doubled to account for the symmetry of the attention and reference matrices; however, alternatively, a single attention value may be used. To train the transformer model to be agnostic to event ordering, model updating subsystem 114 may maximize the identified attention value a′ 12 and update parameters of the transformer model based on the maximization process.

In some embodiments, parameters of the transformer model may be updating during training. Training may be performed using training data, such as training data 300, formed of event sequence data associated with a plurality of users. In some embodiments, to train the transformer model, computing system 102 may cause a series of actions to be performed by its subsystems. As an example, with reference to FIG. 7, training process 700 illustrates some of the steps involved in training a transformer model, such as transformer model 504 of FIG. 5, to be agnostic to event ordering when formulating predictions (e.g., classifications). In some embodiments, training process 700 may begin with training data 300 being retrieved from event sequence data database 122. As mentioned above, training data 300 may include event sequence data associated with a plurality of training users. In some examples, training data 300 may also include modified event sequence data and/or reference matrices for each training user. However, in some cases, training process 700 may facilitate creation of modified event sequence data and reference matrices for some or all of the training users. Persons of ordinary skill in the art will recognize that although computing system 102 is depicted as performing various steps of training process 700, some steps may be performed by other components of system 100. Furthermore, transformer model 702 may be executed using one or more computing resources of computing system 102.

In some embodiments, training event sequence data 710 may be selected (e.g., using event order modification subsystem 110) from training data 300. Training event sequence data 710 may be associated with a first training user. For example, the first training user may be the user associated with event sequence data 200. As another example, the first training user may represent a synthetic user having synthetic event sequence data that can be derived from event sequence data of real users.

Training event sequence data 710 may represent a sequence of events formed of two or more events occurring at two various times. Depending on a number of events included within the sequence of events represented by training event sequence data 710, a certain number of pairs of events may be selected and their ordering switched (e.g., using event order modification subsystem 110). For example, one or more pairs of events (e.g., each including at least a first event occurring at a first time and having a first position within the sequence of events and a second event occurring at a second time and having a second position within the sequence of events) may be selected and their orderings switched (e.g., for each pair of events, the first event is switched to be at the second position within the sequence and the second event is switched to be at the first position within the sequence). The sequence of events including the one or more pairs of events whose ordering has been switched is represented by modified training event sequence data 712. Modified training event sequence data 712 may include the same events as training event sequence data 710, albeit with a different ordering.

In some embodiments, a training reference matrix 714 may be generated (e.g., using model updating subsystem 114) based on training event sequence data 710 and modified training event sequence data 712. Training reference matrix 714 may indicate which pairs of events had their ordering switched. In some examples, training reference matrix 714 is a binary matrix including a first value (e.g., “0”) for each entry associated with a pair of events whose ordering was not switched and a second value (e.g., “1”) for each entry associated with a pair of events whose ordering was switched.

In some embodiments, modified training event sequence data 712 may also be provided to transformer model 702. Transformer model 702 may represent a transformer model to be trained. In some examples, parameters of transformer model 702 (e.g., weights, biases) may be initialized prior to receiving any data.

Transformer model 702 may be configured to receive modified training event sequence data 712 and generate a plurality of embeddings (e.g., using attention generation subsystem 112). The embeddings may represent each event from modified training event sequence data 712. In some embodiments, an embedding may represent a given event in the sequence of events represented by modified training event sequence data 712, as well as any other event occurring prior to that event. Transformer model 702 may be configured to use the embeddings to generate training attention matrix 716. For example, each attention value from training attention matrix 716 may be computed by calculating a dot product of one embedding representing one event from the modified sequence of events with another embedding representing another event from the modified sequence of events. Training attention matrix 716 may indicate upon which events transformer model 702 placed the most importance to the desired prediction task's outcome.

In some embodiments, one or more training attention values 718 may be identified (e.g., using model updating subsystem 114) by computing an element-wise comparison via a loss function of training reference matrix 714 and training attention matrix 716. Training attention values 718 may correspond to the attention values associated with the pairs of events whose orderings were switched. For example, if the first event and the second event form the pair of events whose ordering was switched, then the attention values associated with first event and the second event may be identified.

In some embodiments, a training loss 720 may be computed (e.g., using model updating subsystem 114) based on training attention values 718. For example, a cross entropy loss may be maximized and, subsequently, one or more adjustments 722 may be determined. Adjustments 722 may indicate one or more parameters (e.g., weights, biases) of transformer model 702 that are to be adjusted based on training loss 720. In other words, training loss 720 indicates how “far off” transformer model 702 was using its current parameter settings and may adjust some or all of those parameter settings (e.g., by maximizing the cross entropy with respect to the attention values of the true switched events).

After transformer model 702 receives adjustments 722 and subsequently adjusts its parameters based on adjustments 722, transformer model 702 may determine whether additional training is needed. For example, a determination may be made as to whether a threshold training condition was satisfied. The threshold training condition may be satisfied if a certain number of training users' event sequence data was analyzed, a certain amount of time has elapsed, a certain number of adjustments have been made to transformer model 702, an accuracy of transformer model 702 exceeds a threshold accuracy score, or other criteria, or combinations thereof. If the threshold training condition is not satisfied, then another training user's event sequence data (e.g., training event sequence data 710) may be selected from training data 300 and training process 700 may repeat. However, if the threshold training condition has been satisfied, one or more post-training steps may be performed. For example, validation data may be used to validate the transformer model for deployment. As another example, the transformer model may be stored in model database 124 for future deployment. As yet another example, the transformer model may be deployed for performing inferences.

In some embodiments, model updating subsystem 114 may be configured to update the transformer model by maximizing the one or more attention values to obtain an updated transformer model that is agnostic to event ordering. As mentioned above, the product of the attention matrix and the reference matrix may yield attention values associated with pairs of events that were switched in the modified sequence of events. For example, the product of attention matrix 350 and reference matrix 500 may yield attention value a′₁₂=e′₁·e′₂. Model updating subsystem 114 may be configured to update the transformer model by maximizing this attention value.

Returning to FIG. 1, in some embodiments, model inference subsystem 116 may be configured to receive sample event sequence data representing a sample sequence of events associated with a sample user. Model inference subsystem 116 may be configured to input the sample event sequence data into the updated transformer model to obtain an embedding representing the sample sequence of events. Model inference subsystem 116 may further be configured to identify one or more similar users (i.e., whose interactions with the server are similar to the sample user) based on a similarity metric computed based on the embedding and a set of embeddings associated with the one or more similar users. In some examples, with reference again to FIG. 5, model inference subsystem 116 may input event sequence data 502 representing a sample user into transformer model 504. In some examples transformer model 504 may comprise the trained version of transformer model 702 (i.e., after training process 700 has successfully been completed). Transformer model 504 may generate an embedding representing event sequence data 502 and may use the generated embedding to determine classification 506. In some examples, classification 506 may be determined using one or more distance metrics, such as, but not limited to, a cosine distance, a Hamming distance, a Manhattan distance, and the like.

In some embodiments, model inference subsystem 116 may be configured to generate one or more recommendations for the sample user based on information derived from the one or more similar users. For example, classifying the event sequence data may include identifying one or more users whose event sequence data produced an embedding that is proximate to the embedding generated from event sequence data 502. In some embodiments, an embedding may be generated for each user based on that user's event sequence data, and the users may be clustered into one or more classes. For example, the users may be clustered using one or more clustering techniques, such as, but not limited to, k-means clustering, distribution-based clustering, density-based clustering, and the like. Upon generating the embedding from the event sequence data, model inference subsystem 116 may be configured to identify one or more users whose embeddings are located proximate to the generated embedding (i.e., representing event sequence data 502). As an example, a cosine distance between the generated embedding and each other user's embedding may be calculated. If the distance is less than a threshold distance, then this can indicate that the user shares one or more similar characteristics, at least in terms of their previous event sequences, with another user. Thus, one or more preferences, settings, recommendations, or other information determined for the other user may be applied to the user associated with the generated embedding.

FIG. 8 illustrates an example system for decomposing attention values into event components and temporal components, in accordance with one or more embodiments. For example, FIG. 8 may show illustrative components for decomposing attention values into event components and temporal components, which in turn can be used to determine or update transformer model classifications. As shown in FIG. 8, system 800 may include mobile device 822 and user terminal 824. While shown as a smartphone and personal computer, respectively, in FIG. 8, it should be noted that mobile device 822 and user terminal 824 may be any computing device, including, but not limited to, a laptop computer, a tablet computer, a handheld computer, and other computer equipment (e.g., a server), including “smart,” wireless, wearable, and/or mobile devices. FIG. 8 also includes cloud components 810. In some embodiments, mobile device 822 and/or user terminal 824 may represent examples of client devices 104.

Cloud components 810 may alternatively be any computing device as described above and may include any type of mobile terminal, fixed terminal, or other device. For example, cloud components 810 may be implemented as a cloud computing system and may feature one or more component devices. In some embodiments, computing system 102 of FIG. 1 may be implemented as cloud components 810. It should also be noted that system 800 is not limited to three devices. Users may, for instance, utilize one or more devices to interact with one another, one or more servers, or other components of system 800. It should be noted that, while one or more operations are described herein as being performed by particular components of system 800, these operations may, in some embodiments, be performed by other components of system 800. As an example, while one or more operations are described herein as being performed by components of mobile device 822, these operations may, in some embodiments, be performed by components of cloud components 810. In some embodiments, the various computers and systems described herein may include one or more computing devices that are programmed to perform the described functions. For example, the functionalities described above with respect to subsystems 110-116 may be implemented via one or more computing devices programmed to perform the aforementioned functions. Additionally, or alternatively, multiple users may interact with system 800 and/or one or more components of system 800. For example, in one embodiment, a first user and a second user may interact with system 800 using two different components.

With respect to the components of mobile device 822, user terminal 824, and cloud components 810, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 8, both mobile device 822 and user terminal 824 include a display upon which to display data.

Additionally, as mobile device 822 and user terminal 824 are shown as a touchscreen smartphone and a personal computer, these displays also function as user input interfaces. It should be noted that, in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 800 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, virtual private networks, and/or other virtual storage resources). The electronic storages may store software algorithms, information determined by the processors, information obtained from servers, information obtained from client devices, or other information that enables the functionality as described herein.

FIG. 8 also includes communication paths 828, 830, and 832. Communication paths 828, 830, and 832 may include the Internet, a mobile phone network, a mobile voice or data network (e.g., a 5G or LTE network), a cable network, a public switched telephone network, or other types of communications networks or combinations of communications networks. Communication paths 828, 830, and 832 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 810 may include one or more of the components described in FIG. 1. For example, computing system 102, or one or more of subsystems 110-116, may be implemented using cloud components 810. Cloud components 810 may also include model 802, which may be a machine learning model, artificial intelligence model, etc. (which may be referred to collectively as “models” herein). As an illustrative example, model 802 may represent a transformer model, such as the transformer models implemented, executed, and trained using one or more of subsystems 110-112 of computing system 102 of FIG. 1. In some embodiments, model 802 may represent an untrained model or a model being trained; however, persons of ordinary skill in the art will recognize that this is exemplary and model 802 may be a trained artificial intelligence model.

Model 802 may take inputs 804 and provide outputs 806. The inputs may include multiple datasets, such as a training dataset and a test dataset. Each of the plurality of datasets (e.g., inputs 804) may include data subsets related to user data, predicted forecasts and/or errors, and/or actual forecasts and/or errors. In some embodiments, outputs 806 may be fed back to model 802 as input to train model 802 (e.g., alone or in conjunction with user indications of the accuracy of outputs 806, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., consistency of labels, predicted labels, version metadata, etc.).

In some embodiments, where model 802 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, model 802 may be trained to generate better predictions.

In some embodiments, model 802 may include an artificial neural network. In such embodiments, model 802 may include an input layer and one or more hidden layers. Each neural unit of model 802 may be connected with many other neural units of model 802. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 802 may be self-learning and trained, rather than explicitly programmed, and can perform significantly better in certain areas of problem solving as compared to traditional computer programs. During training, an output layer of model 802 may correspond to a classification of model 802, and an input known to correspond to that classification may be input into an input layer of model 802 during training. During testing, an input without a known classification may be input into the input layer, and a determined classification may be output.

In some embodiments, model 802 may include multiple layers (e.g., where a signal path traverses from front layers to back layers). In some embodiments, backpropagation techniques may be utilized by model 802 where forward stimulation is used to reset weights on the “front” neural units. In some embodiments, stimulation and inhibition for model 802 may be more free-flowing, with connections interacting in a more chaotic and complex fashion. During testing, an output layer of model 802 may indicate whether or not a given input corresponds to a classification of model 802.

System 800 also includes application programming interface (API) layer 850. API layer 850 may allow the system to generate summaries across different devices. In some embodiments, API layer 850 may be implemented on mobile device 822 or user terminal 824. Alternatively, or additionally, API layer 850 may reside on one or more of cloud components 810. API layer 850 (which may be a REST or web services API layer) may provide a decoupled interface to data and/or functionality of one or more applications. API layer 850 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 850 may use various architectural arrangements. For example, system 800 may be partially based on API layer 850, such that there is strong adoption of SOAP and RESTful web services, using resources like Service Repository and Developer Portal, but with low governance, standardization, and separation of concerns. Alternatively, system 800 may be fully based on API layer 850, such that separation of concerns between layers like API layer 850, services, and applications are in place.

In some embodiments, the system architecture may use a microservice approach. Such systems may use two types of layers: front-end layer and back-end layer where microservices reside. In this kind of architecture, the role of API layer 850 may provide integration between front-end and back-end. In such cases, API layer 850 may use RESTful APIs (exposition to front-end or even communication between microservices). API layer 850 may use AMQP (e.g., Kafka, RabbitMQ, etc.). API layer 850 may use incipient usage of new communications protocols such as gRPC, Thrift, etc.

In some embodiments, the system architecture may use an open API approach. In such cases, API layer 850 may use commercial or open-source API platforms and their modules. API layer 850 may use a developer portal. API layer 850 may use strong security constraints applying WAF and DDOS protection, and API layer 850 may use RESTful APIs as standard for external integration.

FIG. 9 illustrates a flowchart of an example process 900 for training a transformer model to be agnostic to event ordering, in accordance with one or more embodiments. In some embodiments, process 900 may begin at operation 902. In operation 902, first event sequence data representing a first sequence of events associated with a user may be retrieved. In some embodiments, the first event sequence data may be associated with a first training user of a plurality of training users and may be selected from training data including event sequence data associated with the training users. In some embodiments, operation 902 may be performed by a subsystem that is the same as or similar to event order modification subsystem 110.

In operation 904, second event sequence data representing a second sequence of events may be generated. The second event sequence data may include the first sequence of events with an order of one or more pairs of events being switched. One or more pairs of events may be selected (e.g., randomly) and an ordering of those pairs of events may be switched. This modified sequence of events may therefore include the same events as the first sequence of events, albeit with a different ordering of the events. The number of pairs of events selected and switched may be dependent on a total number of events within the sequence. In some embodiments, operation 904 may be performed by a subsystem that is the same as or similar to event order modification subsystem 110.

In operation 906, an attention matrix comprising a plurality of attention values representing a similarity between pairs of events from the second sequence of events may be generated using a transformer model. In some embodiments, the transformer model may generate embeddings representing the events from the modified sequence of events. After the embeddings have been generated, the transformer model may calculate attention scores. The attention scores may be computed by calculating a dot product of each embedding with each other embedding. In some embodiments, the dot products may be normalized to obtain probabilities. In some embodiments, operation 906 may be performed by a subsystem that is the same as or similar to attention generation subsystem 112.

In operation 908, one or more attention values from the plurality of attention values corresponding to the one or more pairs of events switched in the second event sequence data may be identified. In some embodiments, an element-wise comparison via a loss function may be computed based on the attention matrix and a reference matrix to identify the attention values. The reference matrix may be a binary matrix having zeros for entries corresponding to pairs of events that were not switched and ones for entries corresponding to pairs of events that were switched. In some embodiments, operation 908 may be performed by a subsystem that is the same as or similar to model updating subsystem 114.

In operation 910, the transformer model may be updated by maximizing the identified attention values to obtain an updated transformer model. In some embodiments, a cross entropy may be maximized based on the identified attention values and corresponding attention values from an attention matrix formed using the unmodified (e.g., first) event sequence data. The updates may include adjustments to one or more parameters of the transformer model. The adjustments may be based on the maximization performed. For example, a loss function may be calculated, and the adjustments may be determined based on the calculated loss function. In some embodiments, a determination may be made as to whether the transformer model satisfies a training condition. For example, the training condition may be satisfied if the transformer model processes training event sequence data associated with each training user. Thus, after the transformer model has been updated, a determination may be made as to whether additional training event sequence data is to be retrieved. If so, process 900 may return to operation 902 where event sequence data representing another sequence of events of another training user may be retrieved and operations 904-910 may be repeated using the new event sequence data. Process 900 may then repeat until the training condition has been satisfied or until another stopping criteria is achieved.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 9.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for updating a transformer model to be agnostic to event ordering.
2. The method of embodiment 1, comprising: retrieving first event sequence data representing a first sequence of events associated with a user; generating second event sequence data representing a second sequence of events comprising the first sequence of events with an order of one or more pairs of events being switched; generating, using a transformer model, an attention matrix comprising a plurality of attention values representing a similarity between pairs of events from the second sequence of events; identifying one or more attention values from the plurality of attention values corresponding to the one or more pairs of events switched in the second event sequence data; and updating the transformer model by maximizing the one or more attention values to obtain an updated transformer model that is agnostic to event ordering.
3. The method of any one of embodiments 1-2, wherein the first sequence of events comprises a plurality of events.
4. The method of embodiment 3, further comprising: randomly selecting, from the plurality of events, the one or more pairs of events to be switched, wherein each of the one or more pairs of events includes a first event occurring at a first time within the first sequence of events and a second event occurring at a second time within the first sequence of events.
5. The method of embodiment 4, wherein generating the second event sequence data comprises: generating the second sequence of events comprising the first sequence of events with the first event switched to occur at the second time and the second event switched to occur at the first time.
6. The method of any one of embodiments 3-5, further comprising: generating, using the transformer model, a plurality of embeddings representing the second sequence of events.
7. The method of embodiment 6, wherein each attention value is associated with a pair of events from the plurality of events.
8. The method of embodiment 7, wherein each attention value is computed based on a pair of embeddings respectively associated with the pair of events.
9. The method of any one of embodiments 6-8, wherein generating the attention matrix comprises: for each of the plurality of embeddings: computing a set of dot products between the embedding and each other embedding from the plurality of embeddings.
10. The method of embodiment 9, further comprising: for each of the plurality of embeddings: normalizing the set of dot products to obtain a set of attention values each indicating how similar the embedding is to each other embedding from the plurality of embeddings.
11. The method of embodiment 10, wherein each attention value from the set of attention values represents a likelihood that an order of a given pair of events associated with each dot product of the set of dot products was switched.
12. The method of any one of embodiments 1-11, further comprising: obtaining a reference matrix indicating which pairs of events were switched within the second event sequence data; and computing a product of the attention matrix and the reference matrix to identify the one or more attention values associated with the pairs of events.
13. The method of any one of embodiments 1-12, further comprising: determining a number of events included within the first sequence of events; and determining a number of pairs of events whose order is to be switched based on the number of events, wherein the one or more pairs of events are selected based on the number of pairs of events.
14. The method of any one of embodiments 1-13, wherein the first sequence of events comprises a plurality of events, the plurality of events include a first event occurring at a first time within the first sequence of events and a second event occurring at a second time within the first sequence of events, the second time being after the first time, wherein the second sequence of events comprises the plurality of events, wherein the first event occurs at the second time within the second sequence of events and the second event occurs at the first time within the second sequence of events.
15. The method of embodiment 14, further comprising: generating, using the transformer model, a first plurality of embeddings representing the first sequence of events.
16. The method of embodiment 15, wherein generating the first plurality of embeddings comprises: generating a first embedding representing the first sequence of events including the first event; and generating a second embedding representing the first sequence of events including the first event and the second event.
17. The method of any one of embodiments 14-16, further comprising: generating, using the transformer model, a second plurality of embeddings representing the second sequence of events.
18. The method of embodiment 17, wherein generating the second plurality of embeddings comprises: generating a first perturbated embedding representing the second sequence of events including the second event; and generating a second perturbated embedding representing the second sequence of events including the second event and the first event.
19. The method of embodiment 18, wherein the attention matrix comprises a first attention matrix comprising a first plurality of attention values.
20. The method of embodiment 19, further comprising: generating, using the transformer model, a second attention matrix comprising a second plurality of attention values representing similarities between the second plurality of embeddings.
21. The method of embodiment 20, wherein maximizing the one or more attention values comprises: computing a loss based on the second attention matrix and the first attention matrix, wherein the transformer model is updated to minimize the loss.
22. The method of any one of embodiments 1-21, further comprising: prior to updating the transformer model, determining, using the transformer model, a classification of the first event sequence data.
23. The method of embodiment 22, further comprising: subsequent to the transformer model being updated, determining an updated classification of the second event sequence data, wherein the updated classification differs from the classification.
24. The method of any one of embodiments 1-23, further comprising: receiving sample event sequence data representing a sample sequence of events associated with a sample user; inputting the sample event sequence data into the updated transformer model to obtain an embedding representing the sample sequence of events; and identifying one or more similar users based on a similarity metric computed based on the embedding and a set of embeddings associated with the one or more similar users.
25. The method of embodiment 24, further comprising: generating one or more recommendations for the sample user based on information derived from the one or more similar users.
26. The method of any one of embodiments 1-25, further comprising: steps for classifying sample event sequence data into one or more classes using the updated transformer model.
27. The method of any one of embodiments 1-26, further comprising: steps for generating embeddings using the transformer model to obtain the attention matrix.
28. The method of any one of embodiments 1-27, wherein the first sequence of events associated with the user comprises interactions of the user with a server.
29. The method of any one of embodiments 1-28, wherein the attention matrix comprises a first attention matrix comprising a first plurality of attention values, the method further comprising: (i) selecting a first user from a plurality of users; (ii) retrieving event sequence data representing a sequence of events associated with the first user; (iii) generating modified event sequence data representing a modified sequence of events comprising the sequence of events associated with the first user wherein an ordering of at least one pair of events from the sequence of events is switched; (iv) generating, using the transformer model, a second attention matrix comprising a second plurality of attention values based on the modified event sequence data; (v) identifying at least one of the second plurality of attention values corresponding to the at least one pair of events; and (vi) updating the transformer model to maximize the at least one of the second plurality of attention values.
30. The method of embodiment 29, further comprising: subsequent to updating the transformer model, determining whether the transformer model satisfies a threshold condition.
31. The method of embodiment 30, further comprising: based on the threshold condition not being satisfied: selecting a second user from the plurality of users; and repeating steps (i)-(vi) using event sequence data associated with the second user.
32. The method of any one of embodiments 30-31, further comprising: based on the threshold condition being satisfied, storing the updated transformer model.
33. The method of any one of embodiments 30-33, wherein the threshold condition being satisfied comprises determining that an accuracy of the updated transformer model is greater than or equal to a threshold accuracy.
34. One or more non-transitory, machine-readable media storing instructions that, when executed by one or more data processing apparatuses, cause operations comprising those of any of embodiments 1-33.
35. A system comprising one or more processors and memory storing instructions that, when executed by the processors, cause the processors to effectuate operations comprising those of any of embodiments 1-33.
36. A system comprising means for performing any of embodiments 1-33.
37. A system comprising cloud-based circuitry for performing any of embodiments 1-33.
38. A service provider comprising one or more processors programmed to perform any of embodiments 1-33.

What is claimed is:

1. A system for using self-supervised learning to update a transformer model to be temporally agnostic to an order in which a sequence of events occurs when generating embeddings for classification tasks, the system comprising:
one or more processors programmed to:
generate a temporally agnostic transformer model by training a transformer model to be agnostic to an order of events within a sequence of events, wherein training the temporally agnostic transformer model comprises configuring the one or more processors to:
for each of a plurality of users:
retrieve event sequence data representing a sequence of events associated with the user, wherein the sequence of events comprises interactions of the user with a server;
randomly select, from the sequence of events, an event pair formed of a first event occurring at a first time and a second event occurring at a second time;
generate perturbated event sequence data representing a modified version of the sequence of events including the first event switched to occur at the second time and the second event switched to occur at the first time;
input the perturbated event sequence data into the transformer model to:
obtain a plurality of perturbated embeddings representing the modified version of the sequence of events, and
generate a perturbated attention matrix comprising a plurality of perturbated attention values each representing a dot product of each of the plurality of perturbated embeddings with each other embedding of the plurality of perturbated embeddings;
retrieve a reference matrix comprising a plurality of entries respectively associated with the events, wherein an entry of the plurality of entries associated with the first event switched with the second event has a first value and each other entry of the plurality of entries has a second value;
compute a product of the perturbated attention matrix and the reference matrix to obtain a first attention value corresponding to the entry from the reference matrix; and
update one or more parameters of the transformer model to maximize the first attention value.

2. The system of claim 1, wherein the one or more processors are further programmed to:
receive sample event sequence data representing a sample sequence of events comprising sample interactions of a sample user with the server;
input the sample event sequence data into the temporally agnostic transformer model, the temporally agnostic transformer model being trained to:
generate a plurality of sample embeddings based on the sample event sequence data,
generate a sample attention matrix comprising a plurality of sample attention values computed based on a dot product of each sample embedding from the plurality of sample embeddings with each other sample embedding from the plurality of sample embeddings, and
classify the sample user into a first classification group based on the sample attention matrix; and
receive, from the temporally agnostic transformer model, a classification result comprising the first classification group.

3. The system of claim 1, wherein the one or more processors are further configured to:
input the event sequence data into the transformer model to:
obtain a plurality of embeddings representing the sequence of events, and
generate an attention matrix comprising a plurality of attention values each representing a dot product of each of the plurality of embeddings with each other embedding of the plurality of embeddings; and
compute a loss based on the plurality of attention values of the attention matrix and the plurality of perturbated attention values of the perturbated attention matrix, wherein maximizing the first attention value comprises minimizing the loss.

4. A method for updating a transformer model to be agnostic to event ordering, the method being implemented via one or more processors, the method comprising:
retrieving first event sequence data representing a first sequence of events associated with a user;
generating second event sequence data representing a second sequence of events comprising the first sequence of events with an order of one or more pairs of events being switched;
generating, using a transformer model, an attention matrix comprising a plurality of attention values representing a similarity between pairs of events from the second sequence of events;
identifying one or more attention values from the plurality of attention values corresponding to the one or more pairs of events switched in the second event sequence data; and
updating the transformer model by maximizing the one or more attention values to obtain an updated transformer model that is agnostic to event ordering.

5. The method of claim 4, wherein the first sequence of events comprises a plurality of events, the method further comprising:
randomly selecting, from the plurality of events, the one or more pairs of events to be switched, wherein each of the one or more pairs of events includes a first event occurring at a first time within the first sequence of events and a second event occurring at a second time within the first sequence of events, wherein generating the second event sequence data comprises:
generating the second sequence of events comprising the first sequence of events with the first event switched to occur at the second time and the second event switched to occur at the first time.

6. The method of claim 5, further comprising:
generating, using the transformer model, a plurality of embeddings representing the second sequence of events, wherein each attention value is associated with a pair of events from the plurality of events and is computed based on a pair of embeddings respectively associated with the pair of events.

7. The method of claim 6, wherein generating the attention matrix comprises:
for each of the plurality of embeddings:
computing a set of dot products between the embedding and each other embedding from the plurality of embeddings; and
normalizing the set of dot products to obtain a set of attention values each indicating how similar the embedding is to each other embedding from the plurality of embeddings, wherein each attention value from the set of attention values represents a likelihood that an order of a given pair of events associated with each dot product of the set of dot products was switched.

8. The method of claim 4, further comprising:
obtaining a reference matrix indicating which pairs of events were switched within the second event sequence data; and
computing a product of the attention matrix and the reference matrix to identify the one or more attention values associated with the pairs of events.

9. The method of claim 4, further comprising:
determining a number of events included within the first sequence of events; and
determining a number of pairs of events whose order is to be switched based on the number of events, wherein the one or more pairs of events are selected based on the number of pairs of events.

10. The method of claim 4, wherein the first sequence of events comprises a plurality of events, the plurality of events including a first event occurring at a first time within the first sequence of events and a second event occurring at a second time within the first sequence of events, the second time being after the first time, wherein the second sequence of events comprises the plurality of events, wherein the first event occurs at the second time within the second sequence of events and the second event occurs at the first time within the second sequence of events, the method further comprising:
generating, using the transformer model, a first plurality of embeddings representing the first sequence of events, wherein generating the first plurality of embeddings comprises:
generating a first embedding representing the first sequence of events including the first event, and
generating a second embedding representing the first sequence of events including the first event and the second event; and
generating, using the transformer model, a second plurality of embeddings representing the second sequence of events, wherein generating the second plurality of embeddings comprises:
generating a first perturbated embedding representing the second sequence of events including the second event, and
generating a second perturbated embedding representing the second sequence of events including the second event and the first event.

11. The method of claim 10, wherein the attention matrix comprises a first attention matrix comprising a first plurality of attention values, the method further comprising:
generating, using the transformer model, a second attention matrix comprising a second plurality of attention values representing similarities between the second plurality of embeddings, wherein maximizing the one or more attention values comprises:
computing a loss based on the second attention matrix and the first attention matrix, wherein the transformer model is updated to minimize the loss.

12. The method of claim 4, further comprising:
prior to updating the transformer model, determining, using the transformer model, a classification of the first event sequence data; and
subsequent to the transformer model being updated, determining an updated classification of the second event sequence data, wherein the updated classification differs from the classification.

13. The method of claim 4, further comprising:
receiving sample event sequence data representing a sample sequence of events associated with a sample user;
inputting the sample event sequence data into the updated transformer model to obtain an embedding representing the sample sequence of events; and
identifying one or more similar users based on a similarity metric computed based on the embedding and a set of embeddings associated with the one or more similar users.

14. The method of claim 13, further comprising:
generating one or more recommendations for the sample user based on information derived from the one or more similar users.

15. The method of claim 4, further comprising:
steps for classifying sample event sequence data into one or more classes using the updated transformer model.

16. The method of claim 4, wherein the first sequence of events associated with the user comprises interactions of the user with a server.

17. The method of claim 4, wherein the attention matrix comprises a first attention matrix comprising a first plurality of attention values, the method further comprising:
(i) selecting a first user from a plurality of users;
(ii) retrieving event sequence data representing a sequence of events associated with the first user;
(iii) generating modified event sequence data representing a modified sequence of events comprising the sequence of events associated with the first user wherein an ordering of at least one pair of events from the sequence of events is switched;
(iv) generating, using the transformer model, a second attention matrix comprising a second plurality of attention values based on the modified event sequence data;
(v) identifying at least one of the second plurality of attention values corresponding to the at least one pair of events; and
(vi) updating the transformer model to maximize the at least one of the second plurality of attention values.

18. The method of claim 17, further comprising:
subsequent to updating the transformer model, determining whether the transformer model satisfies a threshold condition;
based on the threshold condition not being satisfied:
selecting a second user from the plurality of users; and
repeating steps (i)-(vi) using event sequence data associated with the second user; and
based on the threshold condition being satisfied, storing the updated transformer model.

19. The method of claim 18, wherein the threshold condition being satisfied comprises determining that an accuracy of the updated transformer model is greater than or equal to a threshold accuracy.

20. One or more non-transitory, computer-readable media storing computer program instructions that, when executed by one or more processors, effectuate operations comprising:
retrieving first event sequence data representing a first sequence of events associated with a user;
generating second event sequence data representing a second sequence of events comprising the first sequence of events with an order of one or more pairs of events being switched;
generating, using a transformer model, an attention matrix comprising a plurality of attention values representing a similarity between pairs of events from the second sequence of events;
identifying one or more attention values from the plurality of attention values corresponding to the one or more pairs of events switched in the second event sequence data; and
updating the transformer model by maximizing the one or more attention values to obtain an updated transformer model that is agnostic to event ordering.
